(19) United States
(12) Patent Application Publication
(10) Pub. No.: US 2025/0109062 A1
(43) Pub. Date: Apr. 3, 2025

(54) POROUS SINTERED BODY COATED WITH AN ELECTRICALLY CONDUCTIVE COATING AND HAVING A HOMOGENEOUS LAYER THICKNESS

(71) Applicant: SCHOTT AG, Mainz (DE)

(72) Inventors: Sebastian Leugner, Mainz (DE); Thorsten Damm, Mainz (DE); Stephanie Mangold, Mainz (DE); Christian Henn, Mainz (DE); Eveline Rudigier-Voigt, Mainz (DE); Hartmut Bauch, Mainz (DE); Sabine Pichler-Wilhelm, Mainz (DE); Dang Cuong Phan, Aachen (DE)

(73) Assignee: SCHOTT AG, Mainz (DE)

(21) Appl. No.: 18/479,169

(22) Filed: Oct. 2, 2023

Related U.S. Application Data
(63) Continuation of application No. PCT/EP2022/058567, filed on Mar. 31, 2022.

(30) Foreign Application Priority Data
Apr. 1, 2021 (DE) 10 2021 108 387.7

(51) Int. Cl. C03C 17/22; A24F 40/46

(52) U.S. Cl. CPC C03C 17/225; A24F 40/46; C03C 2217/281; C03C 2218/152

(57) ABSTRACT

A coated sintered body is provided that includes a sintered body and electrically conductive coating. The sintered body is made of glass or glass-ceramic and has a surface formed by open pores having an open porosity in a range from 10% to 90%. The electrically conductive coating is bonded to the surface of the sintered body. The electrically conductive coating is configured to heat the sintered body and is on an entire internal pore surface area of the sintered body. The electrically conductive coating has a layer thickness with a variance of not more than 50%.

### CROSS REFERENCE TO RELATED APPLICATIONS

This application is a continuation of International Application PCT/EP2022/058567 filed Mar. 31, 2022, which claims benefit under 35 USC § 119 of German Application 10 2021 108 387.7 filed Apr. 1, 2021, the entire contents of both of which are incorporated herein by reference.

### BACKGROUND

### 1. Field of the Invention

The invention relates generally to an electrically conductive, porous sintered body. The invention relates specifically to a vaporizer unit comprising a liquid storage medium or liquid buffer and a heating unit for storage and controlled release of vaporizable substances. The vaporizer unit here may be used in particular in electronic cigarettes, in devices for administration of drugs, room humidifiers and/or heatable evaporators for release of substances into ambient air, for example fragrances or insect repellents. Electronic cigarettes, also referred to hereinafter as E-cigarettes, are increasingly being used as an alternative to tobacco cigarettes.

### 2. Description of Related Art

Electronic cigarettes typically comprise a mouthpiece and a vaporizer unit, and also an electrical energy source functionally connected to the vaporizer unit. The vaporizer unit has a liquid storage medium connected to a heating element. Particular drugs, especially drugs for the treatment of respiratory pathways and/or of the oral mucosa and/or nasal mucosa, are advantageously administered in a gaseous or vaporized form, for example as an aerosol. Vaporizers of the invention may be used for the storage and release of such drugs, especially in administration devices for such drugs.

Thermally heatable evaporators are increasingly being used to provide an ambience with fragrances. These may in particular be bars, hotel lobbies and/or vehicle interiors, for example the interiors of motor vehicles, especially cars. In the vaporizer unit used here too, a liquid storage medium is connected to a heating element. The liquid storage medium contains a liquid, which is usually a carrier liquid such as propylene glycol or glycerol, for example, in which additives such as fragrances and aromas and/or nicotine and/or drugs are dissolved and/or generally present. The carrier liquid is bound on the inner surface of the liquid storage medium by adsorption processes. A separate liquid reservoir may be provided in order to feed the liquid storage medium with liquid.

It is generally the case that the liquid stored in the liquid storage medium is vaporized by heating of a heating element and desorbed from the wetted surface of the liquid storage medium and can be inhaled by the user. It is possible here to reach temperatures of more than 200° C. The liquid storage medium or liquid buffer therefore has to have high uptake capacity and a high adsorptive action; at the same time, the liquid has to be released or transported quickly at high temperatures. The prior art discloses electronic cigarettes having porous liquid storage media made from organic polymers. Because of the low thermal stability of the polymeric material, there is therefore a need to maintain a minimum distance between the heating element and the liquid storage medium. This prevents a compact design of the vaporizer unit and hence of the electronic cigarette. As an alternative to maintaining a minimum distance, it is possible to use a wick that guides the liquid to be vaporized to the heating coil by capillary action. This wick is usually manufactured from glass fibers. These do have high thermal stability, but the individual glass fibers can break easily.

The situation is similar when the liquid storage medium itself has also been produced from glass fibers. There is therefore a risk that the user will breathe in loose or partly detached fiber fragments. Alternatively, it is also possible to use wicks made of cellulose fibers, cotton or bamboo fibers. These do have a lower risk of breakage than wicks made of glass fibers, but they are less thermally stable. Therefore, vaporizer units used also include those wherein the liquid storage media consist of porous glasses or ceramics. Because of the higher thermal stability of these liquid storage media, it is possible to achieve a more compact design overall of the vaporizer and hence of the electronic cigarette as well. The local vaporization can be achieved in practice by a low pressure combined with a high temperature. In the case of an electronic cigarette, the low pressure is achieved, for example, by the suction pressure when drawing on the cigarette during consumption; the pressure is thus regulated by the consumer. The temperatures in the liquid storage medium that are required for the vaporization are generated by a heating unit. Temperatures attained here are generally more than 200° C., in order to assure rapid vaporization.

The heating power is usually provided by an electrical heating spiral operated by battery or accumulator. The heating output required depends here on the volume to be vaporized and the effectiveness of the heating. In order to avoid breakdown of the liquid as a result of excessively high temperatures, heat is to be transferred from the heating coil to the liquid via contactless radiation. For this purpose, the heating spiral is mounted as close as possible to the vaporization surface, but preferably without touching it. If the coil, by contrast, touches the surface, the liquid is often overheated and decomposed.

However, overheating of the surface can also occur in the case of heat transfer by contactless radiation. The overheating usually arises locally at the surface of the vaporizer opposite the heating coil. This is the case when a large amount of vapor is required in operation and the liquid is not transported quickly enough to the surface of the vaporizer. The energy supply of the heating element thus cannot be consumed for vaporization, the surface dries out and can be heated locally to temperatures well above the vaporization temperature and/or the thermal stability of the liquid storage medium is exceeded. Therefore, exact setting and/or control of temperature is indispensable. A disadvantage here, however, is the resultant complex construction of the electronic cigarette, one consequence of which is high manufacturing costs. Moreover, it may be the case that the regulation of temperature reduces evolution of vapor and hence the maximum possible vapor intensity. EP 2 764 783 A1 describes an electronic cigarette having a vaporizer having a porous liquid storage medium made of a sintered material. The heating element may take the form of a heating spiral or of an electrically conductive coating, wherein the coating has been deposited solely on parts of the shell surfaces of the liquid storage medium. Thus, vaporization is locally limited here too.

US 2011/0226236 A1 describes an inhaler in which the liquid storage medium and the heating element are materially bonded to one another. The liquid storage medium and heating element form a flat composite material. The liquid storage medium, for example made from an open-pore sintered body, functions as a wick and directs the liquid to be vaporized to the heating element. The heating element has been applied to one of the surfaces of the liquid storage medium, for example in the form of a coating. Here too, the vaporization is thus locally limited on the surface, such that there is likewise a risk of overheating.

In order to get round this problem, the prior art proposes vaporizer units where the vaporization takes place not only at the outer surface, also referred to as shell surface, of the vaporizer, but also via the internal surface area thereof. The vapor is evolved not just locally at the surface but throughout the volume of the vaporizer. Thus, the vapor pressure within the vaporizer is largely constant, and capillary transport of the liquid to the surface of the vaporizer is still assured. Accordingly, the vaporization rate is no longer minimized by capillary transport. A prerequisite for a corresponding vaporizer is an electrically conductive and porous material. If an electrical voltage is applied, the whole volume of the vaporizer is heated, and the vaporization takes place throughout the volume.

Corresponding vaporizers are described in US 2014/0238424 A1 and US 2014/0238423 A1. Liquid storage medium and heating element are combined here in one component, for example in the form of a porous body made of metal or a metal mesh. A disadvantage here, however, is that the ratio of pore size to electrical resistance in the case of the porous bodies described cannot be adjusted in a simple manner. There can also be degradation of the coating after the application of the electrically conductive coating as a result of subsequent sintering.

However, the materials described in the prior art cited above are only of limited suitability, if any, for production of composites by means of a sintering process that have both high, adjustable porosity and good electrical conductivities. In general, ceramics are also difficult to coat all over because of their fine porosity and rough surface.

DE 10 2017 123 000 A1 therefore describes vaporizers comprising a sintered body made of glass or glass-ceramic, the entire surface area of which has a conductive coating. By contrast with the case of sintered bodies that have a corresponding coating only on the outer surface, vaporization thus takes place not just at the outer surface but also within the sintered body. For production of corresponding vaporizers, a porous sintered body is first created from glass or glass-ceramic, which is provided in a subsequent step with a relatively thick, conductive coating, for example in the form of an ITO coating. In this case, the coating is applied by adsorption processes from solutions or dispersions, for example by a dipping method. A disadvantage, however, is that the production process becomes costly as a result of the high requirement for conductive material, for example ITO. Furthermore, the subsequent applying of a thick coating may possibly have an adverse effect on the properties of the sintered body. In particular, small pores in the sintered body may be closed by the coating and hence reduce the active surface area of the sintered body.

### SUMMARY

It is therefore an object of the invention to provide a sintered body which is suitable in particular for use as vaporizer in electronic cigarettes and/or devices for administration of drugs and/or thermally heated evaporators for fragrances, and which does not have the disadvantages described above. For instance, a particular aim of the invention is good heatability and exact adjustability of electrical resistance and porosity of the vaporizer. A further object of the invention is that of providing a process for producing a corresponding electrically conductive sintered body.

The invention relates to a coated sintered body having an electrically conductive coating. The sintered body is porous and has an open porosity in the range from 10% to 90%, especially in the range from 50% to 80%, based on the volume of the sintered body. Materials used for the sintered body are glass, glass-ceramics, plastics and/or ceramics. Such sintered bodies and the production thereof are described in DE 10 2017 123 00 A1, which is hereby incorporated in full. In one embodiment, the sintered body additionally comprises metal. The surface area of the sintered body includes the surface area which is formed by the open pores or cavities.

The electrically conductive coating is deposited on the sintered body and is part of a heating device. The surfaces of the open pores and of the open cavities are also bonded here to the electrically conductive coating. The surface area of the sintered body, which also includes the surfaces of the open pores in the volume of the sintered body, is referred to as internal surface area. The shell surfaces of the sintered body are its outer surface which is at least visually accessible and hence visible from the outside. In this context, the surfaces of structures such as bores or channels, for example, are also referred to as shell surfaces. Accordingly, the term “internal surface area”, for example in the case of a cylindrical sintered body, also includes the surface area of the sintered body which is formed by the pores within the body. The internal surface area is thus generally greater than the outer area of the body.

The electrically conductive coating, in one embodiment, is force-fittingly and materially bonded to the surface of the sintered body. In one development, the sintered body has at least one further coating as well as the electrically conductive coating. The additional layer may be disposed here atop the electrically conductive coating or between the sintered body and the electrically conductive coating.

In one embodiment, the coated sintered body has at least two layers in addition to the electrically conductive coating. These may be disposed atop the electrically conductive coating and/or between the sintered body and the electrically conductive coating. In one embodiment, the additional layer is an adhesion promoter layer. In one embodiment, the sintered body has an adhesion promoter layer which is preferably disposed between sintered body and electrically conductive coating and preferably comprises titanium oxide, SiO₂ and/or tin oxide. The additional layer here may be an adhesion promoter layer. The adhesion promoter layer may especially have a coefficient of thermal expansion between the coefficient of thermal expansion of the sintered body and of the electrically conductive coating. It is thus possible to minimize mechanical stresses in the coated sintered body even in the case of fluctuating temperatures, for example on heating of the coated sintered body, and hence to improve the adhesion of the coating. Alternatively or additionally, the adhesion promoter layer may be electrically conductive.

Alternatively or additionally, the sintered body may have been provided with a barrier layer. The barrier layer may be disposed either between sintered body and electrically conductive coating or above the electrically conductive coating (i.e. the electrically conductive coating is between the sintered body and the barrier layer). The barrier layer may likewise be electrically conductive. In one embodiment, the barrier layer is disposed between the surface of the sintered body and of the electrically conductive coating. The barrier layer here may also have adhesion-promoting properties and hence also act simultaneously as adhesion promoter layer. The adhesion promoter layer may likewise have properties of a barrier layer.

For the barrier layer, layers comprising titanium oxide or aluminum oxide in particular have been found to be advantageous. The barrier layer may also take the form of a top layer or passivation layer and may protect the coated sintered body, for example from oxidation. In addition, a barrier layer can prevent particles of the electrically conductive coating from becoming detached and getting into the vapor. Adhesion promoter layer and/or barrier layer are preferably applied by ALD (atomic layer deposition) methods.

Not only the pores or cavities on the shell surfaces of the porous sintered body but also the pores or cavities within the sintered body are provided with the electrically conductive coating. In particular, at least all pores of the sintered body having a pore size of more than 3 μm are provided with the electrically conductive coating. Pores or cavities having diameters or passages of less than 3 μm may, by contrast, also be only partly coated. This is attributable to the poor accessibility of such cavities. For example, in the case of coating by ALD (atomic layer deposition) methods, there may be different or nonuniform penetration by the coating precursors during the coating operation because of the relatively poor accessibility of the corresponding very small cavity.

The internal pore surface area of the sintered body also has been provided with the electrically conductive coating, flows. As a result, when a voltage is applied to the sintered body coated in accordance with the invention, the current flows through the entire volume of the sintered body and hence it is heated throughout its volume. The electrically conductive coating has thus been deposited on the surface of the sintered body and bonded to the surface of the sintered body, and the electrically conductive coating lines the pores within the sintered body, such that, in the case of electrical contacting of at least parts or sections of the sintered body and application of a current, this current flows at least partly through the interior of the sintered body and heats the interior of the sintered body.

Thus, the entire body volume of the sintered body through which current flows is heated, and the liquid to be vaporized is correspondingly vaporized over the entire internal surface area of the sintered body having electrically conductive coating. The vapor pressure is the same throughout the sintered body, and the vapor evolves not just locally at the outer surface of the sintered body that forms the shell surfaces thereof, but also within the sintered body. The electrically conductive coating has been applied on the surface of the sintered body and forms at least part of the pore surface area thereof.

Unlike in the case of vaporizers that have a local heating device, for example a heating spiral or an electrically conductive coating only on the shell surfaces of the sintered body, there is no need for capillary transport to the surface of the sintered body. This prevents the vaporizer from running dry in the case that there is too low a capillary action, and hence also local overheating. This has an advantageous effect on the lifetime of the vaporizer unit.

In one embodiment, the sintered body has an internal surface area of more than 0.1 m²/g. As a result, when it is used in the vaporizer, a high surface area is available for evaporation of the heated liquid. The internal surface area is preferably less than 1 m²/g or even less than 0.7 m²/g. Limitation of the internal surface area is advantageous since chromatography effects during the vaporization process can thus be avoided. In one embodiment, the sintered body has an internal surface area in the range from 0.1 to 0.5 m²/g, preferably in the range from 0.2 to 0.4 m²/g.

The electrically conductive coating has a homogeneous layer thickness. For instance, the local variance in the layer thickness of the electrically conductive coating is not more than 50% of the average layer thickness. It is possible here for variances from the abovementioned homogeneity of the layer thickness of the coating to arise locally in regions having very small pore sizes or passages having a diameter of 3 μm without departing from the invention. The above-described variance in the layer thickness of the electrically conductive coating of max. 50% of the average layer thickness is accordingly satisfied over the coated surface minus the regions having pores or cavities smaller than 3 μm or local artefacts or defects.

The homogeneous layer thickness achieves a constant or virtually constant electrical resistance throughout the volume. Since the heating output of the vaporizer is dependent on the electrical resistance of the coated sintered body, the sintered body thus has a homogeneous heating output throughout the volume of the sintered body. It is thus possible to avoid local temperature maxima that can lead to inhomogeneous vaporization or even to breakdown of the liquid to be vaporized. In a preferred embodiment, the variance in the layer thickness is not more than 30%, not more than 20% or even not more than 5%.

In order to determine the variance in layer thickness, the layer thickness is determined in a sample of the coated sintered body at multiple and at least three sites in the internal surface area by means of a combination of thinning by ion focusing (focused ion beam, FIB) and scanning electron microscopy (SEM). The individual sites in the sintered body at which the layer thickness determination is conducted are spaced apart from one another by at least 10 μm, preferably at least 20 μm. In particular, the measurement points for determination of layer thickness are thus distributed over the specimen. In order to determine the layer thickness of the individual measurement points, FIB is first used to generate a hole locally at a site which extends through the layers applied into the specimen (substrate).

The principle of function of FIB is similar to that of SEM, except that ions (for example Ga ions) are used rather than electrons. Correspondingly, ions are focused at a point by means of ion optics and run across the surface line by line within the measurement region. An acceleration voltage in the range from 2 to 50 kV is applied here, and beam currents in the range from 1 pA to 1 μA are achieved. The removal of material which becomes significant with higher intensities and energies is utilized in order to remove coatings present in the near-surface region (several micrometers) of samples in a controlled manner down to the base material and hence to make a cross section accessible for the subsequent measurement of layer thickness by SEM. The measurement region is chosen such that any obvious defects and artefacts that occur in the coating are outside the measurement region.

In a particularly advantageous configuration of the invention, the electrically conductive coating is a layer applied by an atomic layer deposition (ALD) method. With the aid of the atomic layer deposition method, it is possible here to obtain homogeneous layers particularly with regard to layer thickness. In addition, good control of the deposition process is possible in the atomic layer deposition method. It is thus possible in particular to precisely adjust the desired layer thickness. It is thus also possible to control the electrical resistance and heating output of the sintered body via the correlation between layer thickness of the electrically conductive coating and the electrical resistance of the coated sintered body. In addition, the atomic layer deposition method also enables the deposition of very thin layers. Thus, a further aspect of the invention lies in the use of the atomic layer deposition method or ALD method for production of a sintered body having electrically conductive coating.

In one embodiment of the invention, the electrically conductive coating has a layer thickness in the range from 1 to 1500 nm. In particular, the electrically conductive coating has a layer thickness of less than 1300 nm, preferably of less than 1000 nm or even of less than 700 nm. Thus, the layer thickness of the electrically conductive coating in this embodiment is much less than, for example, electrically conductive coatings that are deposited by dipping methods. The use of comparatively thin electrically conductive coatings can avoid closure or blockage of pores of the sintered body by the electrically conductive coating. This is advantageous since all or almost all open pores are thus available as vaporization volume.

In one embodiment of the invention, the electrically conductive coating comprises a metal M, a metal oxide, metal carbide and/or a metal nitride. Preference is given to using metals, metal oxides, metal carbides or metal nitrides having specific electrical resistivity in the range from 0.016 to 100μΩ*m, more preferably in the range from 0.05μΩ*m to 10μΩ*m and most preferably in the range from 0.1μΩ*m to 10μΩ*m. In one embodiment, the metals, metal oxides, metal carbides or metal nitrides used have a specific electrical resistivity in the range from 0.1 uΩ*m to 5 μΩ*m. Materials having corresponding specific electrical resistivities or electrical conductivities are particularly suitable here as constituents of the electrically conductive coating, since the particularly advantageous electrical resistivities of the sintered bodies thus coated can be achieved by practicable layer thicknesses. Thus, the conductivity of the coating materials used is high enough that even relatively small layer thicknesses of the electrically conductive material are sufficient for adjustment of the electrical conductivity of the sintered body. It is thus possible to save coating material, which is advantageous with regard to process costs.

The metal, metal oxide, metal carbide or metal nitride coatings deposited by ALD methods may, as a result of the process, have electrical resistances greater than the above-described electrical resistances from the literature. The electrical resistance of a coating deposited by ALD methods may be a factor of 100 higher than the electrical resistance of the corresponding compound known from the literature, without departing from the invention.

In addition, relatively thin coatings prevent blockage or closure of individual small pores. At the same time, the required layer thickness of the electrically conducting or electrically conductive material, because of the specific electrical conductivity, is high enough to be able to control the electrical conductivity of the sintered body.

In one embodiment, the electrically conductive sintered body has a specific electrical resistivity in the range from 1 to 10⁹ uohm·m, preferably 100 to 100 000 μohm·m.

Advantageous constituents of the electrically conductive coating have been found to be silver, gold, aluminum, iridium, tungsten, zinc, platinum, palladium, titanium, titanium nitride, titanium carbide, bismuth, indium tin oxide (ITO), aluminum-doped zinc oxide (AZO), silicon, molybdenum, ruthenium, ruthenium oxide, carbon and/or mixtures thereof, including as a layer sequence, or alloys, likewise conceivable as a layer sequence. Alternatively or additionally, the electrically conductive coating may comprise nickel. Another embodiment envisages the use of metal carbides and/or metal nitrides, especially of nitrides and/or carbides of the metals silver, gold, aluminum, iridium, tungsten, zinc, platinum, palladium, titanium, bismuth, molybdenum and/or ruthenium.

The layer thickness of the electrically conductive coating is preferably in the range from 1 to 1500 nm. A particularly advantageous layer thickness has been found to be less than 1000 nm, especially less than 600 nm. The particular layer thickness of the electrically conductive coating depends on the electrical conductivity of the sintered body that is to be achieved and on the specific electrical resistivity of the constituent used in the electrically conductive coating. TABLE 1 shows, in one embodiment, the layer thicknesses of the electrically conductive coating depending on the specific electrical resistivity of the materials used.

TABLE 1
Layer thicknesses as a function of specific electrical resistivity

| | Specific electrical | | |
|---|---|---|---|
| | resistivity [μΩ · m] | Layer thickness | |
| Group | at 20° C. | [nm] | Materials |
| A | 0.016-0.06 | 1-20 | Ag, Cu, Au, |
| | | | Al, Ir, W |
| B | >0.06-10 | 10-1000 | Zn, Pt, Ti, TiNₓ, |
| | | | Bi, ITO, Pd |
| C | >10-60 | 200-1500 | AZO, TiC, doped |
| | | | Si, C |

Group A encompasses materials having a specific electrical resistivity in the range from 0.016 to 0.06 μΩ*m. The layer thickness here is preferably in the range from 1 to 20 nm or even in the range from 1 to 10 nm. In particular, group A comprises the materials silver, gold, copper, aluminum, iridium and tungsten, i.e. in particular materials from the class of the metals. In one working example, the sintered body has a silver coating having a layer thickness in the range from 1 to 10 nm. The materials encompassed by group B have a specific electrical resistivity of 0.06 to 10 μΩ·m. Group B includes, for example, the materials zinc, platinum, indium tin oxide, palladium, titanium and titanium nitride. Coatings composed of materials from group B preferably have a layer thickness in the range from 10 to 1000 nm. Group C encompasses materials having a specific electrical resistivity in the range from 10 to 60 μΩ·m. Thus, group C includes, for example, aluminum-doped zinc oxide (AZO), doped silicon, carbon and titanium carbide. The layer thickness here is preferably in the range from 200 to 1500 nm.

It should be noted that groups A to C comprise typical materials having typical values, and specifically in the case of materials that are compounds, for example ITO or TiN, there can be modifications that are also assigned or can be assigned to another group.

The layer thicknesses listed in TABLE 1 have been found to be advantageous especially in the case of use of a dielectric sintered body, for example a sintered body made of glass or glass-ceramic. Depending on the construction of the sintered body and the material thereof, the layer thicknesses required for establishment of the desired electrical conductivity of the coated sintered body may differ from the layer thicknesses listed in TABLE 1. For example, in the case of sintered bodies made of a composite material composed of glass or glass-ceramic in combination with at least one further metal which is added, for example, in the form of particles or powder, a lower layer thickness (by contrast with TABLE 1) of the electrically conductive coating may be sufficient to achieve a particular desired electrical conductivity of the coated sintered body.

In one embodiment, the electrically conductive layer may also comprise or consist of combinations of materials from groups A to C. It is possible here to employ alloys of the materials, doping with one or more materials or layer sequences and combinations thereof in a productive manner in order to obtain a required electrical conductivity. This may be advantageous in order, for example, to adjust the thickness of the electrically conductive layer or to increase the mechanical stability of a thin layer. In addition, the composition of the electrically conductive coating can adjust the thermomechanical properties thereof, which is advantageous especially in the case of heating applications of the coated sintered body. For example, the coefficient of thermal expansion of the electrically conductive coating may be matched to the sintered body. Mechanical stresses are thus avoided, which increases mechanical stability, especially in the case of thick coatings. It is thus also possible to reduce the tendency to delamination of the coated sintered body. In addition, a combination of materials from groups A to C may be advantageous with regard to the production of the coated sintered body, for example with regard to process time and associated costs.

In one embodiment, the electrically conductive coating may comprise further materials. Preferably, the content of the above-detailed materials in these layers totals at least 50% by weight, preferably at least 85% by weight or even at least 90% by weight. In another embodiment, the electrically conductive coating consists of the abovementioned materials, where the coating may include extrinsic materials with a content of up to 5% by weight, preferably up to 1% by weight.

Especially titanium nitride, indium tin oxide (ITO) and aluminum-doped zinc oxide (AZO), as well as their specific conductivity, also offer the advantage that they can be deposited on the surface of the sintered body with the aid of an atomic layer deposition process. In addition, especially platinum, titanium, titanium nitride, silver and gold are of no toxicological concern, which is advantageous especially in the case of use of the coated sintered body in an electrical cigarette.

In a particularly advantageous embodiment, the electrically conductive coating comprises titanium nitride. The particularly advantageous electrical specific resistivities of the coated sintered body, especially in the range from 1 to 10⁹ μohm*m, preferably 100 to 10⁵ μΩ*m, can thus be achieved in particular by the coating of the sintered body with a titanium nitride layer or a titanium nitride-containing layer having a layer thickness in the range from 10 nm to 1000 nm. The layer thickness is preferably 15 nm to 700 nm, more preferably 20 nm to 500 nm. In addition, the use of titanium nitride as coating material is advantageous since titanium nitride can be deposited efficiently by means of an atomic layer deposition process. Moreover, titanium nitride is benign with regard to health and is used, for example, in the medical sector. In an advantageous embodiment, the electrically conductive coating consists of titanium nitride. The titanium nitride layer is preferably polycrystalline or amorphous.

In one development of the invention, the electrically conductive coating is formed from at least two sublayers. The sublayers may differ in terms of their composition. In one embodiment of this development, the electrically conductive coating has at least two electrically conductive sublayers, where the two sublayers differ in terms of their composition. The two sublayers may thus differ in electrical conductivity. The use of materials having different electrical conductivities offers the option of adjusting the electrical conductivity of the sintered body particularly accurately. Preference is given to applying both or all sublayers by an ALD method. It is also possible that one of the sublayers is deposited by an ALD method and another sublayer is deposited using a different deposition method, for example an galvanic deposition method and/or dipping method, without departing from the invention.

Alternatively, the electrical coating may also take the form of a mixed layer. For example, the electrical coating may be a doped layer. In another embodiment, at least one sublayer takes the form of an adhesion promoter layer or barrier layer. The corresponding sublayer here may also be a dielectric layer. In that case, the corresponding sublayer does not contribute to electrical conductivity of the coated sintered body. Suitable barrier layers and passivation layers contain, for example, Al₂O₃, TiO₂, SiO₂ or a layer sequence of at least two sublayers, for example in the sequence of Al₂O₃ and TiO₂, or a layer sequence composed of at least three sublayers, for example in the sequence of TiO₂, Al₂O₃, TiO₂.

The sintered body may consist of glass, glass-ceramic, plastic and/or ceramic and has an open porosity in the range from 10% to 90% based on the volume of the sintered body. Preferably at least 90%, especially at least 95%, of the total pore volume is present in the form of open pores. Open porosity and pore size distribution can be determined by test methods according to DIN EN ISO 1183 and DIN 66133.

In one development of the invention, the sintered body comprises an electrically conductive material as well as a glass or glass-ceramic component. This allows the electrical conductivity of the coated sintered body which is required for the establishment of a particular resistance, or the layer thickness of the electrically conductive layer to be reduced. In one embodiment of this development, the sintered body takes the form of a composite of at least one electrically conductive material and at least one dielectric material. In one embodiment of this development, the sintered body even without the electrically conductive coating has a basic electrical conductivity which is increased to the desired conductivity by the applying of the electrically conductive coating. The sintered bodies in these embodiments preferably have a relatively high proportion of electrically conductive material. In another embodiment of the invention, the sintered body without the electrically conductive coating has no or only a very low basic electrical conductivity.

A further embodiment of this development envisages the use of a sintered body which constitutes a composite of glass or glass-ceramic with at least two materials of different electrical conductivity. The sintered body here includes at least a first electrically conductive material and at least a second electrically conductive material, where the first electrically conductive material has a lower specific electrical conductivity than the second electrically conductive material. The specific electrical resistivity of the first electrically conductive material is preferably greater than 0.03 μohm·m, especially up to 0.1 μohm·m. In addition, the second electrically conductive material preferably has a specific electrical resistivity of less than 0.1 μohm·m, more preferably less than 0.03 μohm·m.

In particular, the at least one first conductive material forms a skeleton for the sintered body. This skeleton serves to provide a stable element, which also remains mechanically stable at the sintering temperature.

In one embodiment of the invention, the sintered body has an open porosity in the range from at least 10%, preferably 10%-90%, more preferably 30 to 80% and especially in the range from 40 to 80%. The porosity of the invention ensures a high adsorption capacity of the sintered body. For instance, the sintered body, in one embodiment, at a temperature of 20° C. and adsorption time of a few seconds, for example 3-5 seconds, can absorb at least 50% of its open pore volume of propylene glycol. At the same time, the sintered body has good mechanical stability. In particular, sintered bodies having a relatively low porosity show high mechanical stability, which can be particularly advantageous for some applications. In another embodiment, the open porosity is 20% to 50%.

In a further embodiment of the invention, the pores have an average pore size in the range from 1 μm to 1000 μm. The average pore size of the open pores of the sintered body is preferably in the range from 50 to 800 μm, more preferably in the range from 100 to 600 μm. Pores having corresponding sizes are advantageous since they are small enough to create a sufficiently large capillary force and hence to assure the replenishment of liquid to be vaporized, especially in the case of use as liquid storage medium in a vaporizer, and they are simultaneously large enough to enable rapid release of the vapor. In one development, the sintered body has a multimodal, preferably bimodal, pore size distribution with large and small pores or cavities.

The sintered body preferably contains only a small proportion of closed pores. As a result, the sintered body has only a small dead volume, i.e. a volume that does not contribute to adsorption of the liquid to be vaporized. The sintered body preferably has a proportion of closed pores of less than 15% or even less than 10% of the total volume of the sintered body. The proportion of closed pores can be determined by determining the open porosity as described above. The total porosity is calculated from the density of the body. The proportion of closed pores is then found as the difference between total porosity and open porosity. In one embodiment of the invention, the sintered body even has a proportion of closed pores of less than 5% of the total volume.

When used as vaporizer in electronic cigarettes, the sintered body with electrically conductive coating preferably has a specific resistivity in the range from 1 to 109 μohm·m, preferably from 100 to 105 μohm·m. Specific resistivities within the ranges described above are advantageous here especially in the case of relatively small vaporizers as used in electronic cigarettes, for example. The conductivities specified are high enough to assure sufficient evolution of heat for the vaporization. At the same time, excessively high heat outputs that can lead to overheating and hence to breakdown of the liquid constituents are avoided.

The sintered body of the invention can be used either as vaporizer in electronic cigarettes or as vaporizer in medical inhalers. The two applications make different demands on the vaporizer. This is particularly true with regard to the required heating output of the vaporizer. The layer thickness of the electrically conductive coating and the electrical conductivity thus achieved in the coated sintered body can be used to adjust the electrical resistance and hence the heating output of the vaporizer. This is advantageous since the optimal heating output is dependent on the dimensions of the sintered body and of the voltage source used in each case. For example, vaporizers that are used in electronic cigarettes have a small size of a few cm and are usually operated with one or more voltage sources having a voltage of 1 V-12 V, preferably with a voltage of 1 to 5 V. These voltage sources may be standard batteries or standard accumulators. In one embodiment, the vaporizer is operated with an operating voltage in the range from 3 to 5 volts. Electrical resistances in the range from 0.2 to 5 ohms and a heating output of up to 80 W have been found to be particularly advantageous here. By contrast, for example, inhalers for the medical sector can also be operated at voltages of 110V, 220V/230 V or even 380 V. Electrical resistances of up to 3000 ohms and powers of up to 1000 W are advantageous here. Depending on the embodiment of a vaporizer unit or use thereof, different operating voltages, for example greater than 12 V to less than 110 V, resistances, for example greater than 5 ohms, and power ranges, for example greater than 80 W, may also be suitable.

In one embodiment of the invention, the vaporizer has mechanical electrical contacting, electrical contacting by an electrically conducting or conductive connector, or a materially electrically conductive connection. The electrical contacting is preferably effected by means of a solder bond. In particular, contacting is effected at the shell surfaces of the sintered body.

In one embodiment of the invention, the sintered body comprises glass. Particularly advantageous glasses here have been found to be those with a relatively low alkali metal content. A low alkali metal content, especially a low sodium content, is advantageous here from several points of view. Firstly, corresponding glasses have a relatively high transformation temperature Tg, such that, after the electrically conductive coating has been applied, it can be baked at relatively high temperatures. Especially in the case of oxide-based electrically conductive coatings, high baking temperatures have an advantageous effect on the density of the electrically conductive coating and the electrical conductivity of the sintered body. The glasses preferably have a transformation temperature Tg in the range from 300° C. to 900° C., preferably 500° C. to 800° C.

### BRIEF DESCRIPTION OF THE DRAWINGS

FIG. 1 is a schematic diagram of a conventional vaporizer;

FIG. 2 is a schematic diagram of a sintered body with electrical contacting at the shell surfaces of the sintered body;

FIG. 3 is a schematic diagram of a vaporizer with a sintered body coated in accordance with the invention as heating element;

FIG. 4 is a schematic diagram of a sintered body coated in accordance with the invention in cross section;

FIG. 5 is an enlarged detail of the schematic embodiment shown in FIG. 4;

FIG. 6 is a schematic diagram of a detail of the sintered body having electrically conductive coating in an embodiment with a single-layer coating in cross section;

FIG. 7 is the schematic diagram of a detail of the sintered body having electrically conductive coating in an embodiment with a coating composed of three sublayers in cross section;

FIG. 8 is a schematic diagram of a detail of the sintered body having electrically conductive coating in an embodiment with an electrically conductive coating composed of a sublayer and an additional barrier layer;

FIG. 9 is a schematic diagram of a detail of the sintered body having electrically conductive coating in an embodiment with an electrically conductive coating composed of a sublayer and an additional adhesion promoter layer;

FIG. 10 is a schematic diagram of a detail of the sintered body having electrically conductive coating in an embodiment with an electrically conductive coating composed of two sublayers;

FIG. 11 is a SEM image of a sintered body coated by dipping methods;

FIG. 12 is a SEM image of a top view of a working example;

FIGS. 13 to 15 are enlarged details of the working example shown in FIG. 12;

FIG. 16 is a SEM image of a top view of a further working example; and

FIG. 17 is a SEM image of a working example in cross section.

### DETAILED DESCRIPTION

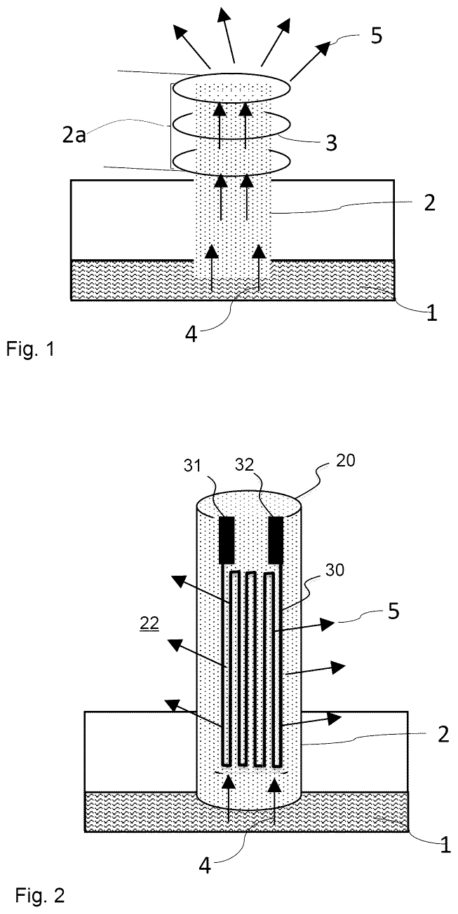

FIG. 1 shows an example of a conventional vaporizer with a porous sintered body 2 as liquid storage medium. The capillary forces in the porous sintered body 2 result in absorption of the liquid 1 to be vaporized by the porous sintered body 2 and further transport of said liquid in all directions of the sintered body 2. The capillary forces are symbolized by the arrows 4. In the upper section of the sintered body 2, a heating spiral 3 is positioned such that the corresponding section 2a of the sintered body 2 is heated by thermal radiation. The heating spiral 3 is therefore brought very close to the shell surfaces of the sintered body 2 and if at all possible is not to touch the shell surfaces. In practice, however, direct contact of heating wire and shell surface is often unavoidable.

In the heating region 2a, the liquid 1 is vaporized. This is shown by the arrows 5. The vaporization rate is dependent on the temperature and the ambient pressure. The higher the temperature and the lower the pressure, the faster the vaporization of the liquid in the heating region 2a.

Since the liquid 1 is vaporized only locally at the shell surfaces of the heating region 2a of the sintered body, this local region has to be heated at relatively high heating outputs in order to achieve rapid vaporization within 1 to 2 seconds. Therefore, high temperatures of more than 200° C. have to be employed. High heating outputs, especially in a locally tightly restricted area, can, however, lead to local overheating and hence possibly to breakdown of the liquid 1 to be vaporized and of the material of the liquid storage medium or wick.

In addition, high heating outputs can also lead to excessively rapid vaporization, such that liquid 1 for vaporization cannot be provided quickly enough by the capillary forces. This likewise leads to overheating of the shell surfaces of the sintered body in the heating region 2a. It is therefore possible to incorporate a unit, for example a voltage, power and/or temperature adjustment unit, temperature control unit or temperature regulation unit (not shown here), but this is at the expense of battery lifetime and limits the maximum vaporization volume.

Disadvantages of the vaporizer which is shown in FIG. 1 and is known from the prior art are thus the local heating method and the associated ineffective heat transfer, the complex and costly control unit, and the risk of overheating and breakdown of the liquid to be vaporized.

FIG. 2 shows a vaporizer unit which is known from the prior art and in which the heating element 30 is disposed directly atop the sintered body 20. In particular, the heating element 30 is fixedly bonded to the sintered body 20. Such a connection can especially be achieved in that the heating element 30 takes the form of a sheet resistor. For this purpose, an electrically conductive coating structured in the shape of a conductor is applied atop the sintered body 20 in the manner of a sheet resistor. One reason why a coating applied directly atop the sintered body 20 as heating element 30 is advantageous is in order to achieve good thermal contact which enables rapid heating. However, the vaporizer unit shown in FIG. 2 also has only a locally limited vaporization area, such that there is the risk of overheating of the surface here too.

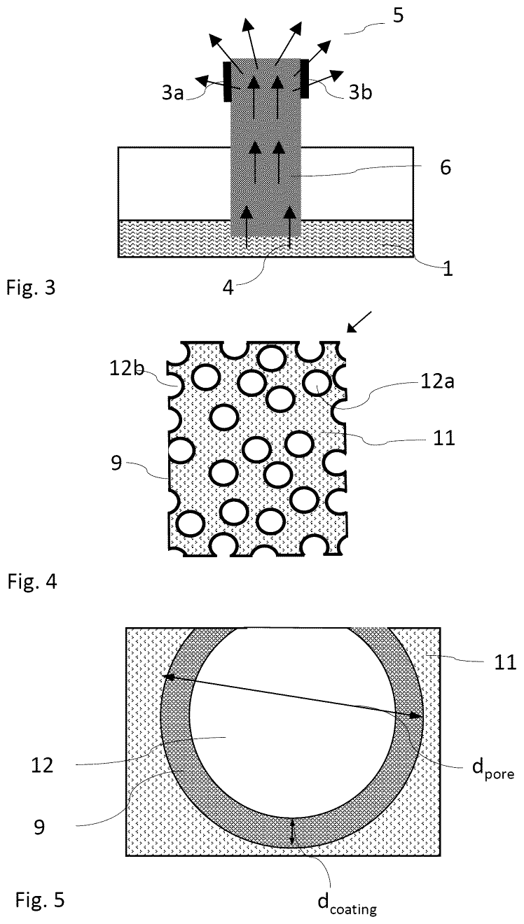

FIG. 3 shows a schematic of the construction of a vaporizer with a sintered body 6 of the invention. Like the porous sintered body 2 in FIG. 1 and FIG. 2 as well, this dips into the liquid 1 to be vaporized. Capillary forces (shown by the arrows 4) result in transport of the liquid to be vaporized into the entire volume of the sintered body 6. The sintered body 6 has an electrically conductive coating, where the surface which is formed by the open pores has been provided with the electrically conductive coating. Thus, on application of electrical voltage, the sintered body 6 is heated throughout the volume having high surface area. Thus, the liquid 1, by contrast with the vaporizer shown in FIG. 2, is evaporated not only at the shell surfaces of the sintered body, i.e. in a locally limited area of the sintered body 6, but throughout the volume of the sintered body 6. There is thus no need for separate capillary transport to the shell surfaces or heated surfaces or elements of the sintered body 6. Moreover, there is no risk of local overheating. Since the vaporization in the volume proceeds much more efficiently than by means of a heating spiral in a locally limited heating region, the vaporization can be effected at much lower temperatures and a lower heating output. A lower electrical power demand is advantageous in that there is thus a rise in the utilization time per accumulator charge, or it is possible to install smaller accumulators or batteries.

FIG. 4 shows the construction of a coated sintered body 6 with open porosity using a schematic cross section through a working example. The coated sintered body 6 has a porous sintered glass matrix 11 with open pores 12a, 12b. A portion of the open pores 12b forms the shell surfaces of the sintered body with their pore surface area, while another portion of the pores 12a forms the interior of the sintered body. All pores of the sintered body have electrically conductive coating 9. The electrically conductive coating 9 preferably contains at least one of the metals or compounds listed in TABLE 2.

TABLE 2
Preferred materials for the electrically conductive coating

| | Specific resistivity [μΩ · m] |
|---|---|
| Material | (at 20° C.) |
| Silver (Ag) | 0.016 |
| Copper (Cu) | 0.017 |
| Gold (Au) | 0.022 |
| Aluminum (Al) | 0.029 |
| Iridium (Ir) | 0.0474 |
| Tungsten (W) | 0.056 |
| Zinc (Zn) | 0.06 |
| Platinum (Pt) | 0.106 |
| Palladium (Pd) | 0.102 |
| Titanium (Ti) | 0.8 |
| Titanium nitride (TiNₓ) | 0.2-12 |
| Bismuth (Bi) | 1.2 |
| Indium tin oxide (ITO) | 1.5-10 |
| Aluminum-doped zinc | 14-50 |
| oxide (AZO) | |
| Silicon (Si) | 1-10⁶ |
| Titanium carbide (TiC) | 60-1000 |

The materials listed in TABLE 2 are particularly suitable for use as material of the electrically conductive coating 9 because of their specific electrical resistivities in the range from 0.016 to 60 μΩ*m. In this case, the electrically conductive coating, in one embodiment, contains only one of the materials listed in TABLE 2. In an alternative embodiment, the electrically conductive coating 9 comprises a mixture or alloy, including as a layer sequence, of at least two materials according to TABLE 2. The electrically conductive coating 9 preferably contains a content of electrically conductive materials having a specific electrical resistivity in the range from 0.016 to 60 μΩ·m of at least 80% by weight or even of at least 95% by weight. In one embodiment, the electrically conductive coating 9 consists of materials having specific resistivities in the range from 0.016 to 60 02.m. Particularly advantageous coatings with regard to the adjustment of specific resistivity have been found to be electrically conductive coatings 9 composed of titanium nitride or aluminum-doped zinc oxide (AZO).

Depending on the layer thickness of the electrically conductive coating 9, it is possible here to set the specific electrical resistivity of the specimen of 1 to 10⁹ μohm·m, preferably 100 to 105 μohm·m.

The electrically conductive coating 9 can especially be deposited by ALD methods. There follows a detailed description of the production process for the coating 9 by four working examples.

### Working Example 1

The procedure for creating a product of the invention with a uniform coating of the internal surface area composed of aluminum zinc oxide (AZO) by atomic layer deposition methods (ALD) is as follows:

A cylindrical, porous substrate consisting of glass, having a porosity of 65% by volume and an average pore size of 75 μm, of geometry D=3 mm, L=4 mm, is introduced into the process chamber of the ALD system. Under vacuum (<1 mbar) and at a temperature of 250° C., in the case of typical process parameters, the respective process gas is first admitted, and pumped away after a reaction time of 60 s in order to remove unreacted process gas. First of all, multiple layers of ZnO are deposited, for which there is alternate admission firstly of the diethylzinc (DEZ) precursor, then, after it has been pumped away, of H₂O as process gas for the subsequent reaction, and a cycle is completed by a purge step (60 s). There follows a further cycle with trimethylaluminum (TMA), followed by the introduction of H₂O and a purge step. This sequence is repeated until the desired layer thickness has been attained. In the present case, the cycle was repeated 800 times. After completion of the coating, the heating is switched off and the process chamber is vented in order to remove the sample.

Thereafter, the specimen was provided with a contacting layer of silver over the entire end face (radius=1.5 mm). Measurement of resistance with an ohmmeter along the length of the specimen (4 mm) gives a resistance of 7 ohms, which corresponds to a specific resistivity of about 1770 μohm*m. Analysis of the deposited layer thickness by focused ion beam (FIB) and scanning electron microscope (SEM) at various points in the specimen has an average layer thickness of 100 nm.

### Working Example 2

The procedure for creating a product of the invention having a uniform coating of the internal surface area consisting of a conductive layer of titanium nitride (TiN) and a protective layer of aluminum oxide (Al₂O₃) by atomic layer coating methods (ALD) is as follows:

A cuboidal porous substrate consisting of glass, having a porosity of 65% by volume and an average pore size of 75 μm and geometry 2 mm×2.5 mm×3 mm is introduced into the process chamber of the ALD system. Under vacuum (<1 mbar) and at a temperature of 430° C., in the case of typical process parameters, the respective process gas is first admitted, and pumped away after a reaction time of 60 s in order to remove unreacted process gas.

In this case, in each cycle of the deposition of the titanium nitride layer, first the TiCl₄ precursor is introduced, the system is purged, and then ammonia is introduced as the second process gas. This cycle is repeated 1000 times.

Subsequently, the outer Al₂O₃ layer is deposited. For this purpose, the process temperature is lowered to 350° C., and 100 ALD cycles are conducted with the trimethylaluminum (TMA) and water precursors.

The total layer thickness of the coating is ascertained by focused ion beam (FIB) and scanning electron microscopy (SEM) and is 160 nm. Resistance measurement with an ohmmeter along the length of the specimen (3 mm) gives a resistance of 3 ohms, which corresponds to a specific resistivity of about 5000 μohm*m.

### Working Example 3

The procedure for creating a porous sintered body having a uniform coating of the internal surface area consisting of a barrier layer of Al₂O₃, a conductive layer of titanium nitride (TiN) and a protective layer consisting of the layer package titanium dioxide (TiO₂)/aluminum oxide (Al₂O₃) and titanium dioxide (TiO₂) by atomic layer deposition methods (ALD) is as follows:

A cuboidal porous substrate consisting of glass, having a porosity of 65% by volume and an average pore size of 75 μm and geometry 2 mm×2.5 mm×3 mm is introduced into the process chamber of the ALD system. The substrate is heated up to a temperature of 350° C. in a nitrogen atmosphere.

Subsequently, an Al₂O₃ layer as adhesion promoter layer or adhesion layer is produced by repeating the following four process steps 100 times: admitting the TMA precursor, purge step, admitting water, and purge step.

The TiN layer is produced by increasing the process temperature to 480° C. First of all, the titanium tetrachloride (TiCl₄) precursor is admitted. Subsequently, a purge step is conducted for 30 seconds, in which nitrogen is admitted into the process chamber and pumped out again. Subsequently, NH₃ as process gas is admitted, in order to induce the subsequent reaction. After a purge time with nitrogen of 30 seconds, the last step of the ALD cycle for production of a TiN monolayer is complete. This cycle is repeated 1300 times.

Next, a layer assembly composed of TiO₂, Al₂O₃ and TiO₂ is to be produced, which functions as protective layer. For this purpose, the process temperature is lowered to 350° C. Subsequently, 50 ALD cycles are conducted with TiCl₄ and water. Next, 50 ALD cycles are conducted with trimethylaluminum (TMA) and water and, finally, another 50 ALD cycles are conducted with TiCl₄ and water.

Measurement of resistance of the coated sintered body with an ohmmeter along the length of the specimen (3 mm) gives a resistance of 2 ohms, which corresponds to a specific resistivity of about 3330 μohm*m. An analysis of the deposited layer thickness by focused ion beam (FIB) and scanning electron microscope (SEM) at various points in the specimen has a layer thickness of 200 nm.

### Working Example 4

For a further example of a sintered body of the invention having a resistance of 1 ohm, a uniform coating of a conductive layer of titanium nitride (TiN) is applied on the internal surface area of a porous composite material composed of 30% glass and 70% steel, 60% porosity. The coating process and coat properties correspond to those as described in working example 2. The resistance of 1 ohm is ascertained with an ohmmeter along the length (height) of the specimen of 3 mm and corresponds to a specific resistivity of the specimen of about 1670 μohm·m.

FIG. 5 shows an enlarged detail of the working example shown in FIG. 4. The pores or the cavity 12 in the sintered glass matrix 11 here has an average diameter Dₚₒᵣₑ and has been provided with the electrically conductive coating 9. The electrically conductive coating 9 here has a layer thickness d_{coating} in the range from 1 nm to 1500 nm, while the average pore diameter is in the range from 1 to 1000 μm. Thus, the coating thickness d_{coating} is very low relative to the pore size Dₚₒᵣₑ. As a result, firstly, only little coating material is required, and so the coating process can accordingly be effected inexpensively and/or relatively quickly. Moreover, as a result of the relatively low layer thickness d_{coating} of the electrically conductive coating, there is no risk that individual pores will be blocked by the conductive coating and hence no longer be available for the vaporization volume.

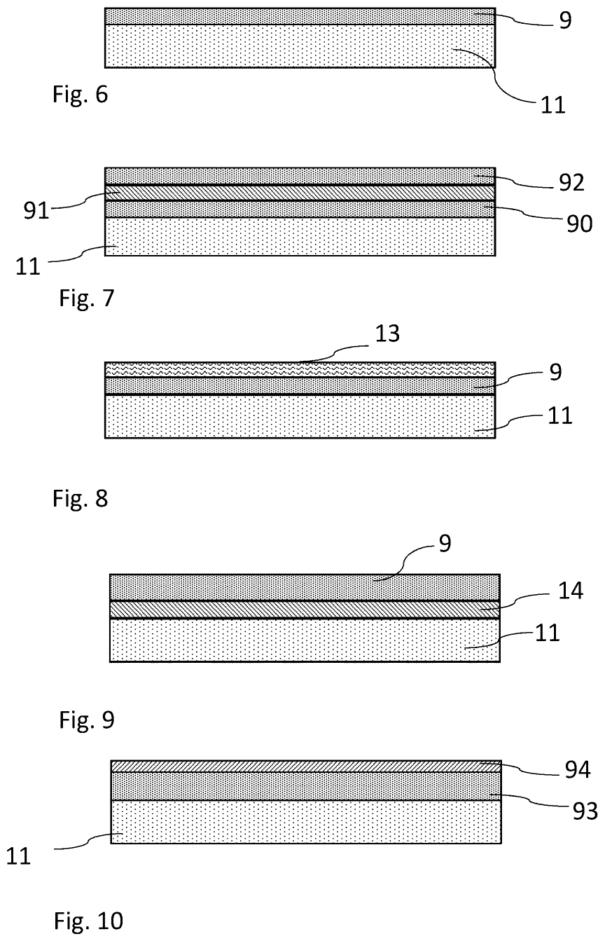

FIGS. 6 to 9 show schematics of cross sections of different working examples. FIG. 6 shows a working example with a single-layer electrically conductive coating 9. The electrically conductive coating, in one working example, consists of a homogeneous layer of an electrically conductive material. In the working example shown in FIG. 6, the electrically conductive coating 9 is a titanium nitride layer deposited by an atomic layer deposition process. The titanium nitride layer here has a layer thickness in the range from 10 to 1500 nm.

FIG. 7 shows a further working example, in which the electrically conductive coating consists of three sublayers 90, 91, 92 and has been deposited on the surface of the sintered body 11. In the working example shown in FIG. 7, the sublayers 90 and 92 have the same composition, while the coating 91 deposited between the sublayers 90 and 92 has a different composition. The use of different sublayers composed of different electrically conductive materials firstly allows exact adjustment of the electrical conductivity of the coating. Moreover, it is also possible, for example, to use materials in the inner sublayer 91 that are advantageous with regard to electrical conductivity, but would otherwise not be as suitable for the respective use, for example materials that do not have sufficient oxidation stability to the application conditions. Alternatively or additionally, the coated sintered body may have coatings in addition to the electrically conductive coating 9.

FIG. 8 shows a development of the invention in which the electrically conductive sintered body has a barrier layer 13 in addition to the electrically conductive coating 9. The barrier layer 13 here may be a dielectric layer and has been applied atop the electrically conductive coating 9. The electrically conductive coating 9 is thus disposed between the sintered body 11 and the passivation layer 13. Thus, the electrically conductive coating 9 is shielded from the environment by the passivation layer 13. It is thus possible to use the correspondingly coated sintered body even under conditions under which the electrically conductive coating 9 is unstable. The passivation layer is preferably an Al₂O₃ layer or TiO₂ layer. Mixed layers are also possible.

FIG. 9 shows a schematic of an embodiment in which an adhesion promoter layer 14 is disposed between the sintered body 11 and the electrically conductive coating 9. The adhesion promoter layer may, for example, be an SnO₂ layer or a TiO₂ layer.

FIG. 10 shows a further working example in which the electrically conductive coating is formed from the two sublayers 93, 94. Sublayer 93 is an electrolytically deposited silver layer; sublayer 94 is a titanium nitride layer and was deposited on the silver layer by ALD methods.

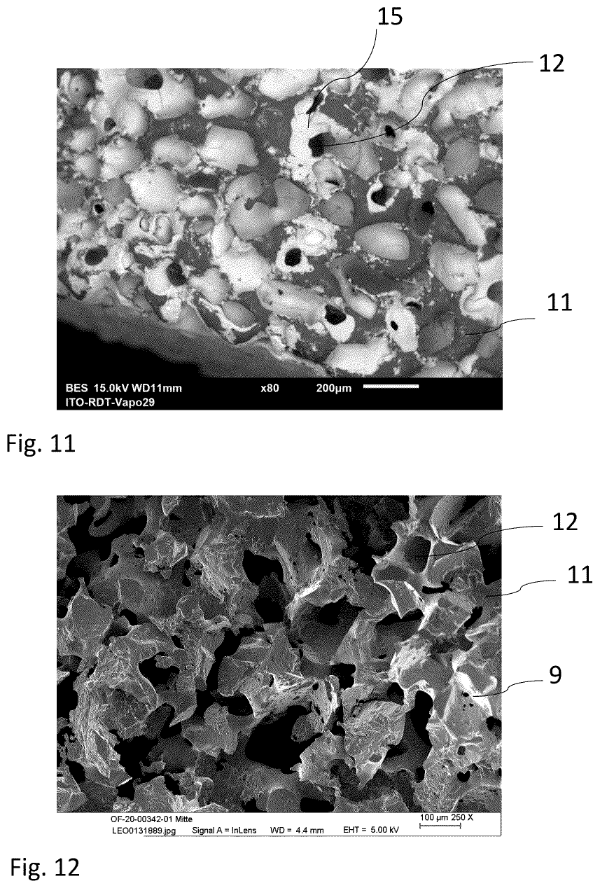

FIG. 11 shows an SEM image of a sintered body coated by dip coating as a comparative example. The sintered body 11 here has pores 12 coated with an electrically conductive layer 15. It becomes clear from FIG. 11 that the electrically conductive coating has not been deposited homogeneously over the entire surface area of the sintered body. In addition, the coating 15 has a relatively high layer thickness, and so some pores are closed by the electrically conductive coating.

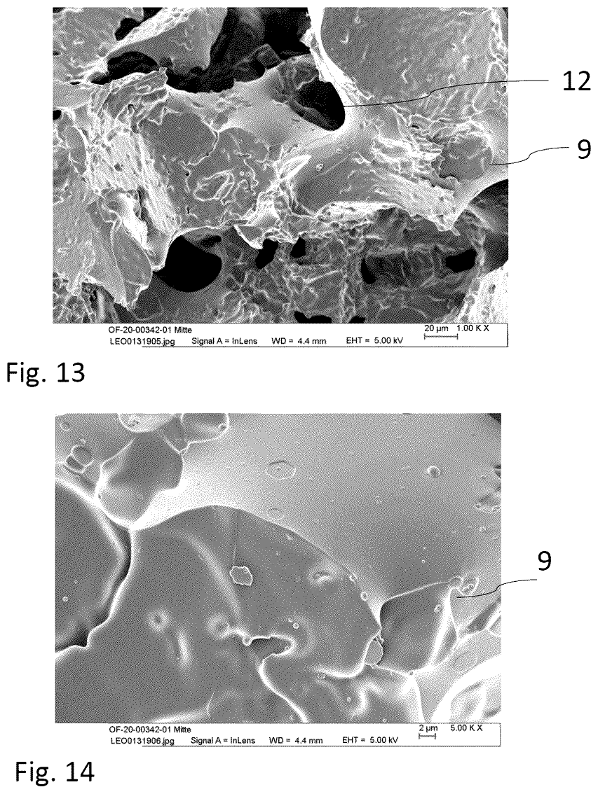

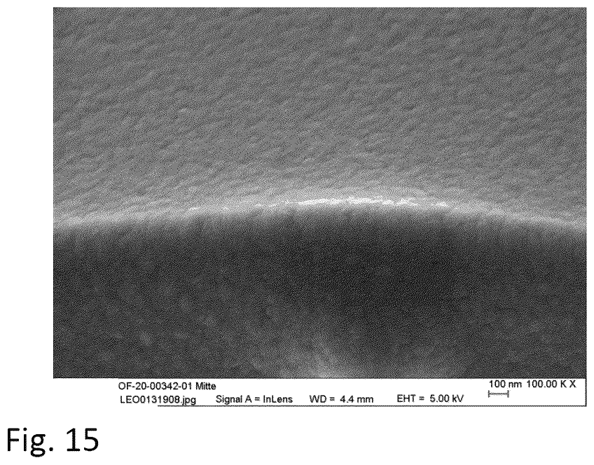

FIG. 12 shows an SEM image of a working example of a sintered body coated in accordance with the invention. The electrically conductive coating 9 is distributed here homogeneously over the surface of the sintered body 11. The working example shown in FIG. 12 is a porous sintered body made of glass, coated with a titanium nitride layer. The titanium nitride layer has a layer thickness of 200 nm and was applied to the sintered body by ALD methods. FIGS. 13 to 15 are enlarged details of the working example shown in FIG. 12. It becomes clear that the electrically conductive coating has a homogeneous structure even at very high magnification and fully covers the surface of the sintered body.

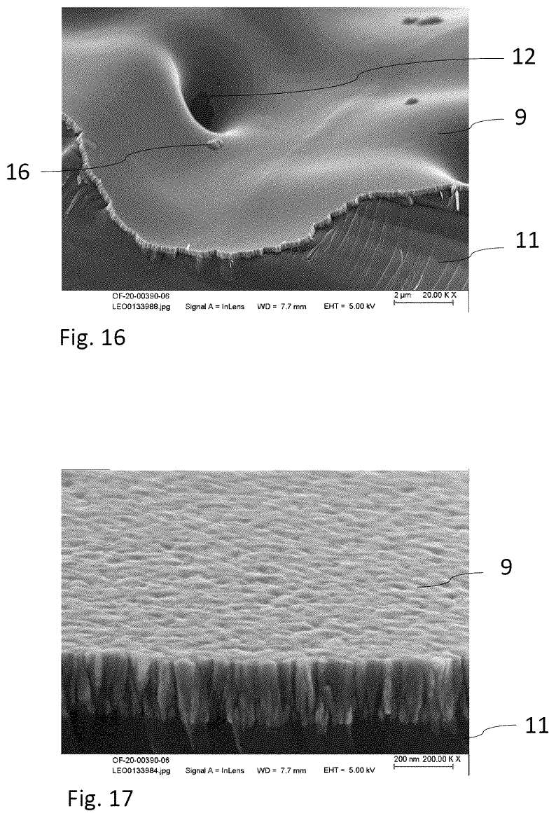

FIG. 16 shows the SEM image of a further working example in which the electrically conductive coating 9 has been removed in subregions, such that the surface of the sintered body 11 is visible in the corresponding subregions. This working example also shows a homogeneous surface of the electrically conductive coating 9. The individual artefacts 16 are attributable to irregularities in the substrate surface.

FIG. 17 shows the SEM image of a cross section of a further working example. The cross section shows the high homogeneity of the layer thickness of the electrically conductive coating 9.

What is claimed is:

1. A coated sintered body, comprising:
a sintered body that comprises glass or glass-ceramic and has a surface formed by open pores having an open porosity in a range from 10% to 90%;
an electrically conductive coating bonded to the surface of the sintered body, the electrically conductive coating being configured to heat the sintered body,
wherein the electrically conductive coating on an entire internal pore surface area of the sintered body and has a layer thickness with a variance of not more than 50%.

2. The coated sintered body of claim 1, wherein the variance is not more than 5%.

3. The coated sintered body of claim 1, wherein the layer thickness is 10 nm to 1500 nm.

4. The coated sintered body of claim 1, wherein the electrically conductive coating comprises titanium nitride.

5. The coated sintered body of claim 1, wherein the sintered body is a composite formed of the glass or the glass-ceramic and a material selected from the group consisting of metal, ceramic, and mixtures or alloys thereof.

6. The coated sintered body of claim 1, wherein the electrically conductive coating comprises a material selected from a group consisting of metal, metal oxide, metal nitride, metal carbide, and mixtures or alloys thereof.

7. The coated sintered body of claim 6, wherein the material has a specific electrical resistivity in a range from 0.016 to 60μΩ·m.

8. The coated sintered body of claim 1, wherein the electrically conductive coating comprises a metal having a specific electrical resistivity in a range from 0.016 to 0.06 μΩ·m.

9. The coated sintered body of claim 1, wherein the metal is selected from a group consisting of silver, copper, aluminum, iridium, gold, molybdenum, tungsten, and mixtures or alloys thereof, and wherein the electrically conductive coating has a layer thickness in a range from 1 to 20 nm.

10. The coated sintered body of claim 1, wherein the electrically conductive coating comprises a material selected from a group consisting of a metal, metal oxide, metal nitride, and mixtures or alloys thereof, wherein the material has a specific electrical resistivity in a range from >0.06 to 10 μΩ·m, and wherein the electrically conductive coating has a layer thickness in a range from 10 to 1000 nm.

11. The coated sintered body of claim 10, wherein the material is selected from a group consisting of zinc, platinum, palladium, titanium, bismuth, indium tin oxide, ruthenium, ruthenium oxide, titanium nitride, and mixtures or alloys thereof.

12. The coated sintered body of claim 1, wherein the electrically conductive coating comprises a material selected from a group consisting of a metal, metal oxide, metal carbide, metal nitride, and mixtures or alloys thereof, wherein the material has a specific electrical resistivity in a range from >10 to 60 μΩ·m, and wherein the electrically conductive coating has a layer thickness in a range from 200 to 1500 nm.

13. The coated sintered body of claim 12, wherein the material is selected from a group consisting of aluminum-doped zinc oxide, doped silicon, titanium carbide, and mixtures or alloys thereof.

14. The coated sintered body of claim 1, wherein the electrically conductive coating comprises a material selected from a group consisting of silver, gold, aluminum, iridium, tungsten, zinc, platinum, palladium, titanium, titanium nitride, titanium carbide, silicon, bismuth, titanium carbide, indium tin oxide, aluminum-doped zinc oxide, molybdenum, ruthenium, ruthenium oxide, nickel, and mixtures or alloys thereof.

15. The coated sintered body of claim 1, wherein the electrically conductive coating is formed from at least two sublayers.

16. The coated sintered body of claim 15, wherein the at least two sublayers have different compositions from one another.

17. The coated sintered body of claim 1, further comprising a layer disposed on the conductive coating and/or between the sintered body and the electrically conductive coating.

18. The coated sintered body of claim 17, wherein the layer comprises an adhesion promoter layer and/or a barrier layer.

19. The coated sintered body of claim 1, wherein the electrically conductive coating is an atomic layer deposition layer.

20. The coated sintered body of claim 1, wherein the coated sintered body is configured for use as a heating element in a vaporizer or an electrical cigarette.
